(19) United States
(12) Patent Application Publication
(10) Pub. No.: US 2018/0259704 A1
(43) Pub. Date: Sep. 13, 2018

(54) DISPLAY DEVICE

(71) Applicant: SAMSUNG DISPLAY CO., LTD., Yongin-si (KR)

(72) Inventors: Myunghun BAEK, Seoul (KR); Taechang KIM, Anyang-si (KR); Dongcheol LEE, Asan-si (KR); Taeksun SHIN, Yongin-si (KR); Dohun KIM, Suwon-si (KR); Mansoo KIM, Asan-si (KR); Hyunhyang KIM, Suwon-si (KR); Youngmin PARK, Hwaseong-si (KR); Junhee SON, Asan-si (KR); Wonchul LEE, Seoul (KR); Younggyu JUNG, Seongnam-si (KR)

(21) Appl. No.: 15/977,524

(22) Filed: May 11, 2018

Related U.S. Application Data
(63) Continuation-in-part of application No. 15/196,204, filed on Jun. 29, 2016.

(30) Foreign Application Priority Data
Nov. 3, 2015 (KR) 10-2015-0154074
Nov. 21, 2017 (KR) 10-2017-0155505

(51) Int. Cl. F21V 8/00; G02F 1/1335; G02F 1/1333; G02F 1/1345

(52) U.S. Cl. CPC G02B 6/0073; G02B 6/0055; G02B 6/0088; G02F 1/133514; G02F 2201/123; G02F 1/133308; G02F 1/13452; G02F 2201/121; G02F 1/133305

(57) ABSTRACT

A display device includes: a display panel curved in a first direction; a light source which emits a light; and a light guide plate which guides the light from the light source toward the display panel. The light guide plate includes an exit surface curved in the first direction corresponding to a shape of the display panel and an incidence surface, which is defined by a side surface of the light guide plate in the first direction, where the light from the light source is incident onto the incidence surface. The incidence surface is substantially parallel to a normal line at a central portion of the exit surface.

### CROSS-REFERENCE TO RELATED APPLICATION

This application is a continuation-in-part of U.S. patent application Ser. No. 15/196,204, filed on Jun. 29, 2016, which claims priority to Korean Patent Application No. 10-2015-0154074, filed on Nov. 3, 2015. This application claims priority to Korean Patent Application No. 10-2017-0155505, filed on Nov. 21, 2017, and all the benefits accruing therefrom under 35 U.S.C. §§ 119, the contents of which in their entirety are herein incorporated by reference.

### BACKGROUND

### 1. Field

Exemplary embodiments of the invention relate to a display device, and more particularly, to a display device including a light guide plate with increased light incidence efficiency.

### 2. Discussion of Related Art

In general, a flat panel display (“FPD”) device, such as a liquid crystal display (“LCD”) device or an organic light emitting diode (“OLED”) display device, typically includes a plurality electric-field generating electrodes and an electro-optical active layer disposed therebetween. The LCD device may include a liquid crystal layer as the electro-optical active layer, and the OLED display device may include an organic light emitting layer as the electro-optical active layer.

In recent times, as the LCD device is widely used as a display device of a television receiver, the screen size of the LCD device has been increased. However, as the screen size of the LCD device increases, a viewing angle difference between a case in which a viewer looks at a center portion of a screen and a case in which the viewer looks at left and right end portions of the screen increases. Herein, the viewing angle is defined as an angle between a sight line of the viewer looking at a screen and a tangent line of the screen the viewer is looking at, and the difference therebetween is defined as the viewing angle difference.

Accordingly, the display device may be concavely or convexly incurvated into a curved form to compensate for the viewing angle difference. Such a display device may be classified into two types with respect to a viewer: a portrait type having a vertical length longer than a horizontal length and curved in a vertical (longitudinal) direction; and a landscape type having a horizontal length longer than a vertical length and curved in a horizontal (longitudinal) direction.

### SUMMARY

In a display device curved concavely or convexly, a backlight unit for a curved display panel thereof may include a curved light guide plate. As the light guide plate is curved, a side surface of the light guide plate in the longitudinal direction is inclined and the light guide plate may not be effectively aligned with light sources. Accordingly, light incidence efficiency, at which the light emitted from a light source unit is incident onto the light guide plate, is lowered, resulting in a decrease in luminance.

Exemplary embodiments of the invention may be directed to a curved type display device including a light guide plate with improved light incidence efficiency.

According to an exemplary embodiment, a display device includes: a display panel curved in a first direction; a light source which emits a light; and a light guide plate which guides the light from the light source toward the display panel. In such an embodiment, the light guide plate includes an exit surface curved in the first direction corresponding to a shape of the display panel and an incidence surface, which is defined by a side surface of the light guide plate in the first direction, where the light from the light source is incident onto the incidence surface. In such an embodiment, the incidence surface is substantially parallel to a normal line at a central portion of the exit surface.

In an exemplary embodiment, the light source may include a light emission surface through which the light source emits the light, and the light emission surface of the light source and the incidence surface of the light guide plate may be substantially parallel to each other.

In an exemplary embodiment, the display device may further include a bottom chassis in which the light guide plate is accommodated, and the bottom chassis may include a back surface portion curved in the first direction and a sidewall portion which is substantially parallel to the incidence surface of the light guide plate.

In an exemplary embodiment, the display device may further include a circuit board between the incidence surface of the light guide plate and the sidewall portion of the bottom chassis, the light source being mounted on the circuit board.

In an exemplary embodiment, the display device may further include an adhesive tape between the circuit board and the sidewall portion of the bottom chassis.

In an exemplary embodiment, the display device may further include a mold frame coupled to the bottom chassis. In such an embodiment, the mold frame may fasten the light guide plate and support the display panel.

In an exemplary embodiment, the incidence surface of the light guide plate and the light emission surface of the light source may be spaced apart from each other by a distance in a range from about 0.1 mm to about 0.5 mm.

In an exemplary embodiment, an angle between the incidence surface and the exit surface of the light guide plate may be about (π/2-A/2R) radian, where R denotes a radius of curvature of the light guide plate in the first direction, and A denotes a length of the light guide plate in the first direction.

In an exemplary embodiment, a length of a side of the light guide plate in the first direction may be greater than a length of a side of the light guide plate in a second direction which is perpendicular to the first direction.

In an exemplary embodiment, the light source may be disposed on opposite side surfaces of the light guide plate in the first direction.

In an exemplary embodiment, the light guide plate may include incidence surfaces, which are defined by the opposite side surfaces of the light guide plate in the first direction, respectively, where the light from the light source is incident onto the incidence surfaces, and the incidence surfaces may be substantially parallel to each other.

In an exemplary embodiment, the display panel and the exit surface of the light guide plate may be curved in the second direction which is perpendicular to the first direction.

### BRIEF DESCRIPTION OF THE DRAWINGS

The above and other features of the invention will become more apparent by describing in detail exemplary embodiments thereof with reference to the accompanying drawings, in which:

FIG. 1 is an exploded perspective view illustrating a display device according to an exemplary embodiment;

FIG. 2 is a cross-sectional view taken along line I-I′ of FIG. 1;

FIGS. 3 and 4 are a cross-sectional perspective view and a cross-sectional view illustrating a backlight unit according to an exemplary embodiment;

FIGS. 5A, 5B, 6A and 6B are views illustrating a method of forming a light guide plate according to an exemplary embodiment; and

FIGS. 7A, 7B and 7C are views illustrating simulation results of a degree of light leakage generated according to a shape of a light guide plate.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

In the drawings, thicknesses of a plurality of layers and areas are illustrated in an enlarged manner for clarity and ease of description thereof. When a layer, area, or plate is referred to as being “on” another layer, area, or plate, it may be directly on the other layer, area, or plate, or intervening layers, areas, or plates may be therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. Or” means “and/or.” As used herein, the term “and/or” includes any and all combinations of one or more of the associated listed items. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined at the specification.

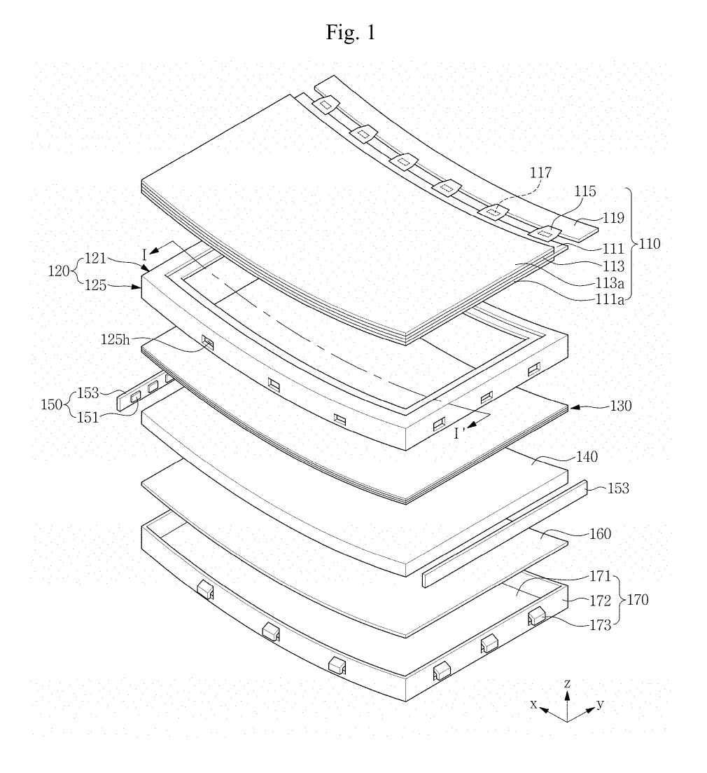

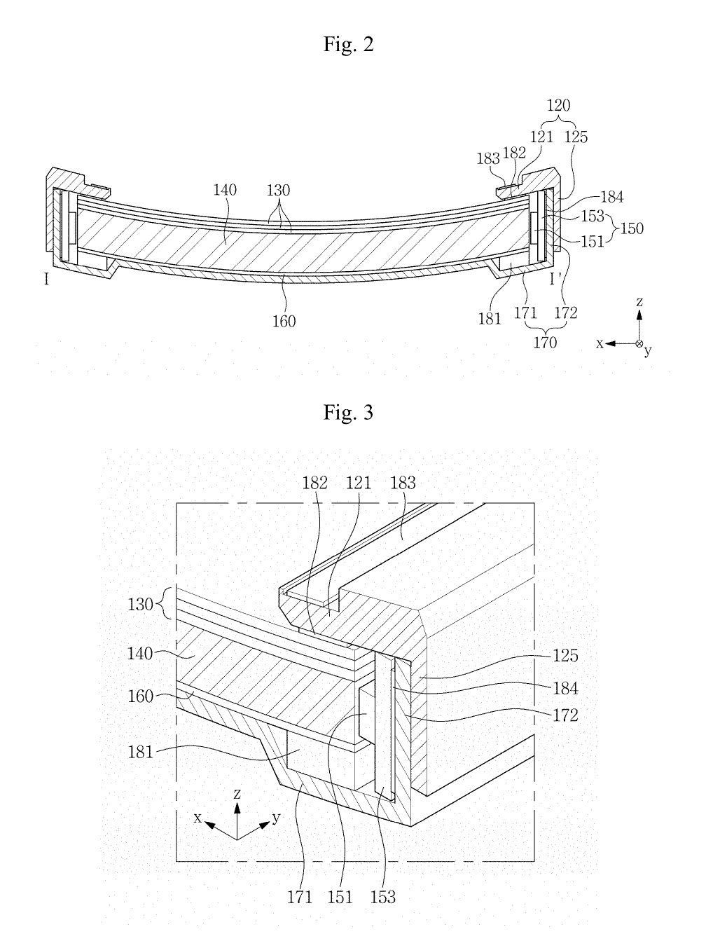

Hereinafter, an exemplary embodiment of a display device a will be described with reference to FIGS. 1 and 2.

FIG. 1 is an exploded perspective view illustrating a display device according to an exemplary embodiment, and FIG. 2 is a cross-sectional view taken along line I-I′ of FIG. 1.

Referring to FIGS. 1 and 2, an exemplary embodiment of the display device includes a display panel 110, a mold frame (e.g., a middle chassis) 120, an optical sheet 130, a light guide plate 140, a light source unit 150, a reflective sheet 160, a bottom chassis 170, and the like. In such an embodiment, the mold frame 120, the optical sheet 130, the light guide plate 140, the light source unit 150, the reflective sheet 160 and the bottom chassis 170 collectively define a backlight unit.

The display panel 110 may be in a quadrangular plate shape. The display panel 110 receives an electric signal from an outside to display an image. The display panel 110 includes a first substrate 111, a second substrate 113 opposing the first substrate 111, and a liquid crystal layer (not illustrated) between the first substrate 111 and the second substrate 113.

The first substrate 111 includes a plurality of pixel electrodes arranged in a matrix form, a thin film transistor for applying a driving voltage to each of the pixel electrodes, and various signal lines for driving the pixel electrodes and the thin film transistor.

The second substrate 113 is disposed to oppose the first substrate 111. The second substrate 113 may include a common electrode including a transparent conductive material, and a color filter. The color filter may include a red color filter, a green color filter and a blue color filter.

In an exemplary embodiment, as described above, the first substrate 111 includes the pixel electrode and the second substrate 113 includes the common electrode and the color filter, but not being limited thereto. Alternatively, the common electrode may be disposed on the first substrate 111, and the pixel electrode may be disposed on the second substrate 113. Alternatively, the common electrode and the color filter may be disposed on the side of the first substrate 111. Alternatively, all of the pixel electrode, the common electrode, and the color filter may be disposed on the side of the first substrate 111.

The liquid crystal layer (not illustrated) is interposed between the first substrate 111 and the second substrate 113, and is rearranged by an electric field generated between the pixel electrode and the common electrode. Such a rearranged liquid crystal layer adjusts transmittance of a light emitted from the backlight unit, and the adjusted light passes through the color filter, and thereby an image is displayed to an outside.

In an exemplary embodiment, a lower polarizing plate 111a may be disposed on a back surface of the first substrate 111, and an upper polarizing plate 113a may be disposed on an upper surface of the second substrate 113. The upper polarizing plate 113a may have an area less than or substantially equal to an area of the second substrate 113 of the display panel 110. In such an embodiment, the lower polarizing plate 111a may have an area less than or substantially equal to an area of the first substrate 111 of the display panel 110.

The upper polarizing plate 113a may allow only a predetermined polarized light of a light arriving from the outside to pass through and may absorb or block the remaining light. The lower polarizing plate 111a may allow only a predetermined polarized light of a light emitted from the backlight unit to pass through and may absorb or block the remaining light

A driving circuit board 119 may be disposed on at least one side of the display panel 110. The driving circuit board 119 may provide various control signals and a power signal for driving the display panel 110.

The display panel 110 and the driving circuit board 119 may be electrically connected to each other by a flexible printed circuit board 115. The flexible printed circuit board 115 may be, for example, a chip-on-film (“COF”) or a tape-carrier-package (“TCP”). In an exemplary embodiment, the number of the flexible printed circuit boards 115 provided in the display device may vary depending on the size, the driving scheme or the like of the display panel 110.

A driving chip 117 may be disposed or mounted on the flexible printed circuit board 115. The driving chip 117 may generate various driving signals for driving the display panel 110. The driving chip 117 may include a driving integrated circuit (“IC”) or a source IC, into which a timing controller and a data driving circuit are integrated.

The display panel 110 has a predetermined radius of curvature. Two relatively long sides (hereinafter, “long sides”) of the display panel 110 have concavely curved shapes with a constant curvature, and two relatively short sides (hereinafter, “short sides”) of the display panel 110 have straight linear shapes. Alternatively, the short sides of the display panel 110 may have concavely curved shapes with a constant curvature, and the long sides of the display panel 110 may have straight linear shapes. Alternatively, the long side and the short side may each have a concavely curved shape with a predetermined curvature.

Referring to FIGS. 1 and 2, in an exemplary embodiment, the display panel 110 has long sides in an x-axis direction and short sides in a y-axis direction, and the display panel 110 is curved in the x-axis direction and is not curved in the y-axis direction. In such an embodiment, the curved display panel 110 has a curved line in a longitudinal direction, and the curved display panel 110 has a straight line in a width direction. However, exemplary embodiments are not limited thereto, and the display panel 110 may be curved both in the x-axis direction and in the y-axis direction.

In an exemplary embodiment, the display panel 110 may include a flexible material, and may be curved as placed on the bottom chassis 170 and the mold frame 120. In such an embodiment, the bottom chassis 170 and the mold frame 120 fasten the display panel 110 in a way such that the display panel 110 has a predetermined radius of curvature.

Accordingly, in such an embodiment, the bottom chassis 170 and the mold frame 120, which will be described in detail below, have a predetermined radius of curvature in a shape similar to that of the display panel 110. In such an embodiment, the optical sheet 130, the light guide plate 140, the reflective sheet 160 and the like, which are disposed on the bottom chassis 170, also have a predetermined radius of curvature in a shape similar to that of the bottom chassis 170. The display panel 110 has a predetermined non-zero curvature. A curvature is defined as the inverse of a radius of curvature.

In an exemplary embodiment, the display panel 110 may be curved in one of various ways. In one exemplary embodiment, for example, where a direction in which images are displayed on the display panel 110 is defined as an upward direction and a direction opposite thereto is defined as a downward direction, the display panel 110 may be curved convexly in the downward direction or the upward direction. However, the direction in which the display panel 110 is curved is not limited thereto. In one alternative exemplary embodiment, for example, a center portion of the display panel 110 may be convex upwardly, that is, convex to the side of a user. In another alternative exemplary embodiment, a part of the display panel 110 may be convex upwardly and another part of the display panel 110 may be convex downwardly.

The mold frame 120 supports an edge portion of a back surface of the display panel 110, and defines a space, in which the optical sheet 130, the light guide plate 140, the light source unit 150 and the reflective sheet 160 are accommodated, together with the bottom chassis 170.

The mold frame 120 may have a polygonal frame shape with an empty space defined therein. In one embodiment, for example, the mold frame 120 may have a quadrangular frame shape in which an empty space is defined. The mold frame 120 may have a single (e.g., monolithic) shape (e.g., integrally formed as a single unitary and indivisible unit) or a shape divided into a plurality of pieces.

Referring to FIGS. 1 and 2, the mold frame 120 may include a horizontal portion 121 which supports an edge portion of the back surface of the display panel 110 and a vertical portion 125 which extends substantially in the vertical direction from the horizontal portion 121. The vertical portion 125 may have a coupling groove 125h to be engaged with a protrusion 173 of the bottom chassis 170 to be described below.

In an exemplary embodiment, an adhesive tape 183 may be disposed on an upper surface of the horizontal portion 121 of the mold frame 120 such that the display panel 110 and the mold frame 120 may be coupled to each other. In such an embodiment, another adhesive tape 182 may be disposed on a lower surface of the horizontal portion 121 of the mold frame 120 so that the mold frame 120 may be coupled to the optical sheet 130 and the light guide plate 140 to be described below. The adhesive tapes 182 and 183 may be double-sided tapes and may be black tapes for substantially preventing light leakage.

The optical sheet 130 is disposed on the light guide plate 140, and diffuses or collimates a light transmitted from the light guide plate 140. The optical sheet 130 includes a diffusion sheet, a prism sheet and a protective sheet. The diffusion sheet, the prism sheet and the protective sheet may be sequentially stacked on the light guide plate 140 in the listed order.

The prism sheet is configured to collimate the light guided by the light guide plate 140, the diffusion sheet is configured to diffuse the light collimated by the prism sheet, and the protective sheet is configured to protect the prism sheet. The light passed through the protective sheet is provided toward the display panel 110.

The light guide plate 140 supplies the light provided from the light source unit 150 uniformly to the display panel 110. The light guide plate 140 may be in a quadrangular plate shape, but exemplary embodiments are not limited thereto. In an exemplary embodiment, where a light source includes a light emitting diode (“LED”) chip, the light guide plate 140 may be in one of various shapes including predetermined grooves or protrusions. The shape of the light guide plate 140 will be described in detail below.

Although exemplary embodiment where the light guide plate 140 has a plate shape are described above for convenience of description, but not being limited thereto. Alternatively, the light guide plate 140 may be in the shape of a sheet or a film to reduce the thickness of the display device. Herein, the light guide plate 140 may be a plate or a film for guiding light.

The light guide plate 140 may include a material having light transmittance, e.g., polycarbonate or an acrylic resin such as polymethylmethacrylate (“PMMA”), to efficiently guide light.

The light source unit 150 includes a light source 151 and a circuit board 153 on which the light source 151 is disposed. In an exemplary embodiment, the light source 151 may be disposed to oppose a light incidence surface of the light guide plate 140. In such an embodiment, the light source 151 may emit a light to the light incidence side surface of the light guide plate 140. The light source 151 may include an LED chip (not illustrated) and a package (not illustrated) for accommodating the LED chip. In one exemplary embodiment, for example, the LED chip (not illustrated) may be a gallium nitride (GaN)-based LED chip that emits a blue light.

The number of the light source 151 provided in the display device may be various modified in consideration of a size of the display panel 110, luminance uniformity, and the like. The circuit board 153 may be a printed circuit board (“PCB”) or a metal PCB.

The light source unit 150 may be disposed on one side surface, opposite side surfaces or all four side surfaces of the light guide plate 140 in consideration of the size of the display panel 110, luminance uniformity, and the like. In such an embodiment, the light source unit 150 may be disposed to face at least one of edge portions of the light guide plate 140.

In an exemplary embodiment, although not illustrated in FIG. 1, a wavelength conversion unit (not illustrated) may be disposed between the light guide plate 140 and the light source unit 150. The wavelength conversion unit (not illustrated) may include a material for converting the wavelength of light. In one exemplary embodiment, for example, the wavelength conversion unit may convert a wavelength of a blue light emitted from the blue LED light source into a white light.

The reflective sheet 160 may include, for example, polyethylene terephthalate (“PET”), to have reflectance. One surface of the reflective sheet 160 may be coated with a diffusion layer including, for example, titanium dioxide. In an exemplary embodiment, the reflective sheet 160 may include a material that includes a metal such as silver (Ag).

The bottom chassis 170 is coupled to the mold frame 120 and accommodates the optical sheet 130, the light guide plate 140, the light source unit 150, the reflective sheet 160, and the like. The bottom chassis 170 maintains a framework of the display device and protects various components accommodated therein.

The bottom chassis 170 may include a back surface portion 171, a sidewall portion 172 substantially perpendicularly extending from the back surface portion 171, and the protrusion 173 protruding outwardly from the sidewall portion 172.

The protrusion 173 may be inserted into the coupling groove 125h of the mold frame 120 so that the mold frame 120 and the bottom chassis 170 may be coupled to each other. However, exemplary embodiments are not limited thereto, and the mold frame 120 and the bottom chassis 170 may be coupled to each other in one of various coupling methods known in the art.

The bottom chassis 170 may include a rigid metal material having high heat radiation characteristics. In one exemplary embodiment, for example, the bottom chassis 170 may include at least one of stainless steel, aluminum, an aluminum alloy, magnesium, a magnesium alloy, copper, a copper alloy, and an electrogalvanized steel sheet.

In an exemplary embodiment, another adhesive tape 184 may be disposed inside the sidewall portion 172 of the bottom chassis 170 so that the bottom chassis 170 and the circuit board 153 may be coupled to each other. In such an embodiment, another adhesive tape 181 may be disposed on the back surface portion 171 of the bottom chassis 170 so that the bottom chassis 170 may be coupled to the reflective sheet 160 and the light guide plate 140. Accordingly, the optical sheet 130, the light guide plate 140 and the reflective sheet 160 are fixed to have a curved surface by the bottom chassis 170 and the mold frame 120 which are curved. The adhesive tapes 181 and 182 may be double-sided tapes and may be black tapes to substantially prevent light leakage.

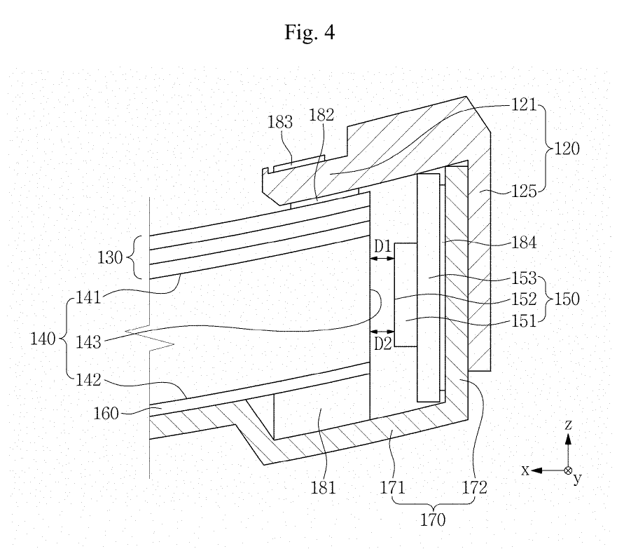

Hereinafter, an exemplary embodiment of the backlight unit will be described in detail with reference to FIGS. 3 and 4. FIG. 3 is a cross-sectional perspective view illustrating a backlight unit according to an exemplary embodiment, and FIG. 4 is a cross-sectional view thereof.

In an exemplary embodiment, the light guide plate 140 is a quadrangular flat plate which has an upper surface, a lower surface, left and right side surfaces in an x-axis direction, and front and rear side surfaces in a y-axis direction. The light guide plate 140 is curved in the x-axis direction according to the shape of the bottom chassis 170. The upper surface of the curved light guide plate 140 corresponds to an exit surface 141, through which the light is emitted toward the display panel 110, the lower surface of the light guide plate 140 corresponds to a reflection surface 142, from which the light is reflected by the reflective sheet 160, and one of or both of the left and right side surfaces of the light guide plate 140 correspond to an incidence surface 143, onto which the light is incident from the light source 151. However, exemplary embodiments are not limited thereto. In an alternative exemplary embodiment, the light guide plate 140 may be curved in the y-axis direction, and one of or both of the front and rear side surfaces of the light guide plate 140 may correspond to the incidence surface 143 onto which the light is incident from the light source 151.

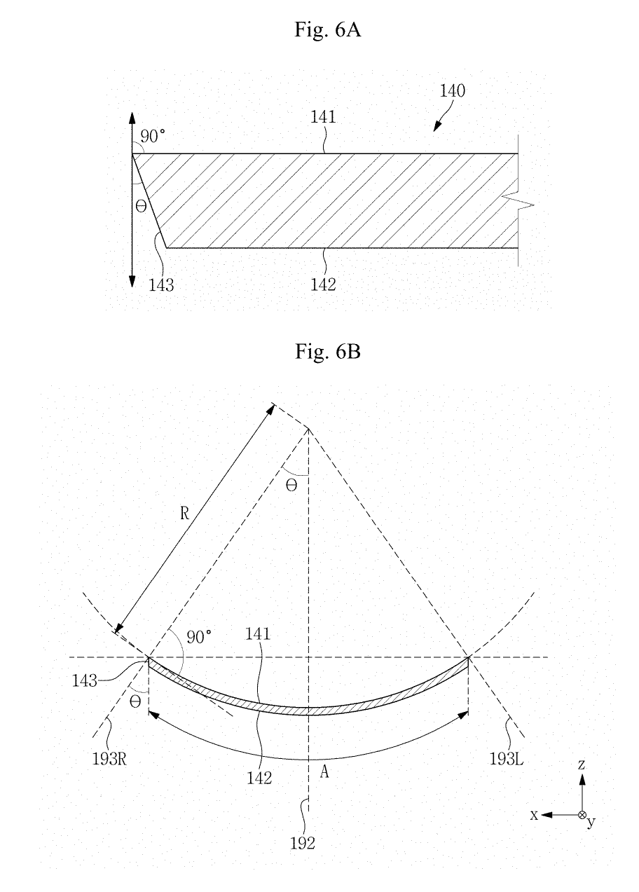

In an exemplary embodiment, as illustrated in FIG. 4, the incidence surface 143 of the light guide plate 140 forms an acute angle with the exit surface 141 of the light guide plate 140. In such an embodiment, the incidence surface 143 is not perpendicular to the exit surface 141 and the reflection surface 142, but is oblique with respect thereto. The incidence surface 143 is parallel to a normal line 192 at the center of the light guide plate 140 (see FIG. 6B). In such an embodiment, the front and rear side surfaces (not illustrated) of the light guide plate 140 in the y-axis direction may be perpendicular to the exit surface 141 and the reflection surface 142.

In an exemplary embodiment, the bottom chassis 170, the light guide plate 140, the mold frame 120, the display panel 110 and the like may form concentric circles on an x-z plane, and normal lines 192 at centers of the bottom chassis 170, the light guide plate 140, the mold frame 120, the display panel 110 and the like may be substantially the same as each other. In such an embodiment, radius of curvatures of the bottom chassis 170, the light guide plate 140, the mold frame 120, the display panel 110 and the like may be substantially equal to each other. Herein, the meaning of that the respective radius of curvatures thereof are substantially equal to each other include the case in which the respective radius of curvatures of the bottom chassis 170, the light guide plate 140, the mold frame 120, the display panel 110, and the like, which form concentric circles have slight difference due to respective thicknesses and intervals thereof.

The bottom chassis 170 includes the back surface portion 171 and the sidewall portion 172 bent from the back surface portion 171. In an exemplary embodiment, the back surface portion 171 is curved in the x-axis direction so that the light guide plate 140 to be disposed on the back surface portion 171 may be curved and fixed. The left and right sidewall portions 172 in the x-axis direction are substantially parallel to the normal line 192 at the center of the bottom chassis 170. In such an embodiment, the left and right sidewall portions 172 in the x-axis direction may be substantially parallel to the incidence surface 143 of the light guide plate 140. Accordingly, the left and right sidewall portions 172 in the x-axis direction form an obtuse angle with the back surface portion 171. The front and rear sidewall portions (not illustrated) in the y-axis direction may be perpendicular to the back surface portion 171. However, when curved in the y-axis direction, the front and rear sidewall portions in the y-axis direction may form an obtuse angle with the back surface portion 171.

The back surface portion 171 and the sidewall portion 172 of the bottom chassis 170 may be formed by pressing a metal plate having a predetermined rigidity with a metal mold. In an exemplary embodiment, the sidewall portion 172 of the bottom chassis 170 is substantially parallel to the normal line 192 at the center of the bottom chassis 170, as described above. In such an embodiment, the sidewall portions 172 of the bottom chassis 170 may all be parallel to each other. Accordingly, the back surface portion 171, which is curved, and the sidewall portion 172, which is substantially parallel to the normal line 192 at the center of the bottom chassis 170, may be formed by pressing a flat metal plate with a metal mold without a separate bending process.

The circuit board 153 is disposed at one of or both of the left and right sidewall portions 172 of the bottom chassis 170 in the x-axis direction. The adhesive tape 184 may be disposed between the circuit board 153 and the sidewall portion 172. The circuit board 153 is in the form of a flat plate extending in the y-axis direction.

In an exemplary embodiment, as illustrated in FIG. 4, a light emission surface 152 of the light source 151 through which a light is emitted is substantially parallel to the incidence surface 143 of the light guide plate 140 through which the light is incident. Accordingly, a distance between the light emission surface 152 of the light source 151 and the incidence surface 143 of the light guide plate 140 is substantially equal at an upper side and a lower side in the z-axis direction (i.e., D1=D2). The distance between the light emission surface 152 of the light source 151 and the incidence surface 143 of the light guide plate 140 may be in a range from about 0.1 millimeter (mm) to about 0.5 mm. However, exemplary embodiments are not limited thereto, and alternatively, the light emission surface 152 of the light source 151 may contact the incidence surface 143 of the light guide plate 140.

The light source 151 may have a shape such as a quadrangular flat plate, a circular flat plate, or the like. However, the shape of the light source 151 is not limited to the flat plate shape.

In an exemplary embodiment, as shown in FIG. 3, the vertical portion 125 of the mold frame 120 is coupled to the sidewall portion 172 of the bottom chassis 170. A lower surface of the horizontal portion 121 of the mold frame 120 may be curved along an edge of the curved light guide plate 140. The optical sheet 130, the light guide plate 140 and the reflection sheet 160 are fixed by the mold frame 120, the bottom chassis 170 and the respective adhesive tapes 181 and 182.

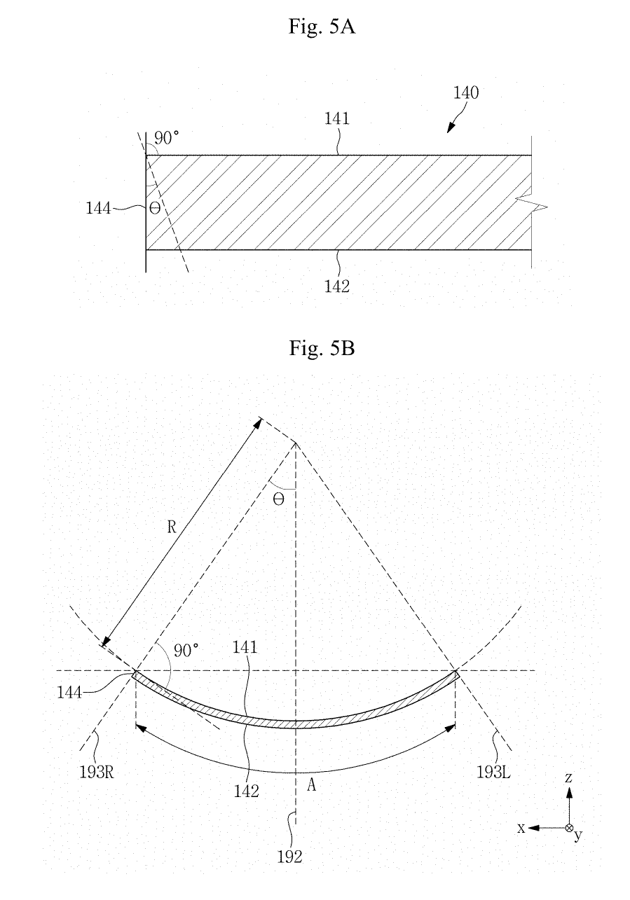

Hereinafter, an exemplary embodiment of a method of forming the incidence surface 143 of the light guide plate 140 will be described in detail with reference to FIGS. 5A, 5B, 6A, and 6B. Herein, for convenience of description, an exemplary embodiment of a method of forming the light guide plate 140 having a length A and curved to have a radius of curvature R. A longitudinal direction and a curved direction are substantially the same as those described above.

FIG. 5A is a cross-sectional view illustrating a light guide plate 140 which is not curved, and FIG. 5B is a cross-sectional view illustrating a light guide plate 140 which is curved. The light guide plate 140 illustrated in FIG. 5A includes an incidence surface 144 perpendicular to the exit surface 141 and the reflection surface 142. As illustrated in FIG. 5B, although the light guide plate 140 illustrated in FIG. 5A is curved, an angle between the incidence surface 144 and the exit surface 141 and an angle between the incidence surface 144 and the reflection surface 142 maintain a substantially right angle in the light guide plate 140. Accordingly, the incidence surface 144 of the curved light guide plate 140 is parallel to normal lines 193R and 193L of the curved exit surface 141 at a point where the exit surface 141 meets the incidence surface 144, and the incidence surface 144 of the curved light guide plate 140 forms an angle θ with the center normal line 192. Accordingly, the incidence surface 144 of the curved light guide plate 140 forms an angle θ with the sidewall portion 172 of the bottom chassis 170 which is substantially parallel to the center normal line 192 and the light source 151 and the circuit board 153 which are attached to the sidewall portion 172 and have a flat plate shape. The angle θ is about A/2R (radian), R is a radius of curvature of the light guide plate 140, and A is a length of the curved light guide plate 140.

Accordingly, as illustrated in FIG. 5B, when the light guide plate 140 having the perpendicular side surface 144 is curved, a distance between the incidence surface 144 and the light emission surface 152 at an upper side in the z-axis direction (i.e., close to the exit surface 141) becomes greater than a distance between the incidence surface 144 and the light emission surface 152 at a lower side in the z-axis direction (i.e., close to the reflection surface 142).

As illustrated in FIG. 6A, according to an exemplary embodiment, a light guide plate 140 including an incidence surface 143 which is not perpendicular to the exit surface 141 and the reflection surface 142 may be provided. In such an embodiment, the incidence surface 143 forms an angle θ with the normal lines 193R and 193L of the curved exit surface 141 at a point where the exit surface 141 meets the incidence surface 143, and the incidence surface 143 and the exit surface 141 form an angle π/2-θ. In such an embodiment, as described above, the angle θ is about A/2R (radian), R is a radius of curvature of the light guide plate 140, and A is a length of the curved light guide plate 140.

In an exemplary embodiment, as illustrated in FIG. 6B, when the light guide plate 140 illustrated in FIG. 6A is curved, an angle between the incidence surface 143 and the exit surface 141 of the light guide plate 140 maintains an angle πn/2-θ. Accordingly, as illustrated in FIG. 6B, the incidence surface 143 of the curved light guide plate 140 forms an angle of 0 (radian) with the center normal line 192. In such an embodiment, the incidence surface 143 of the curved light guide plate 140 is substantially parallel to the center normal line 192. Accordingly, the incidence surface 143 is also substantially parallel to the sidewall portion 172 of the bottom chassis 170 which is substantially parallel to the center normal line 192 and the light source 151 and circuit board 153 which are attached to the sidewall portion 172 and have a flat plate shape.

Accordingly, in such an embodiment, when the light guide plate 140 having the inclined side surface 143 is curved, a distance between the incidence surface 143 and the light emission surface 152 at an upper side in the z-axis direction (i.e., close to the exit surface 141) is substantially equal to a distance between the incidence surface 143 and the light emission surface 152 at a lower side in the z-axis direction (i.e., close to the reflection surface 142). In such an embodiment, as the distance between the incidence surface 143 of the light guide plate 140 and the light emission surface 152 of the light source 151 may be maintained uniform and the overall distance may be reduced, light leakage phenomenon that may occur between the incidence surface 143 of the light guide plate 140 and the light emission surface 152 of the light source 151 may be substantially reduced.

In an exemplary embodiment, as described above, the light guide plate 140 may be curved not only in the x-axis direction but also in the y-axis direction. In such an embodiment, the radius of curvature R in the cross-sectional view on the x-z plane illustrated in FIG. 6B may differ depending on a position of the light guide plate 140 in the y-axis direction. In one exemplary embodiment, for example, as further away from the center of the light guide plate 140 toward opposing sides (e.g., front and rear sides) of the light guide plate 140 in the y-axis direction, the light guide plate 140 becomes more concave on the x-z plane, and the radius of curvature R on the x-z plane is reduced. Accordingly, the angle π/2-θ between the incidence surface 143 and the exit surface 141 of the light guide plate 140 may become less, as further away from the center of the light guide plate 140 toward the front and rear sides of the light guide plate 140, so that all parts of the incidence surface 143 is substantially parallel to the center normal line 192.

The light guide plate 140 of FIG. 6A may be formed by cutting the perpendicular side surface 144 of the light guide plate 140 of FIG. 5A at the oblique angle described above. In an exemplary embodiment, where the light guide plate 140 is also curved in the y-axis direction, the light guide plate 140 may be formed by cutting the perpendicular side surface 144 of the light guide plate 140 at difference angles according to the position of the light guide plate 140 in the y-axis direction, as described above.

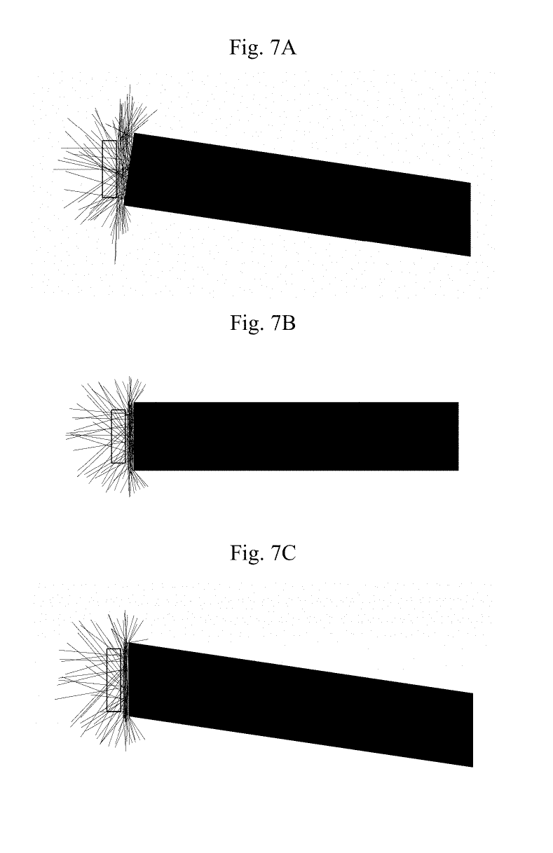

Hereinafter, effects of exemplary embodiments of the invention will be described with reference to FIGS. 7A, 7B and 7C.

FIGS. 7A, 7B and 7C are views illustrating simulation results of a degree of light leakage that occurs according to the shape of the light guide plate 140.

FIGS. 7A, 7B and 7C show simulation results each showing light leakage occurring at the incidence surface of the light guide plate 140 in a case where the light guide plate 140 illustrated in FIG. 5A is curved in the above-described direction, in a case where the light guide plate 140 illustrated in FIG. 5A is not curved, and in a case where the light guide plate 140 illustrated in FIG. 5B is curved in the above-described direction.

As illustrated in FIG. 7A, in the case where the light guide plate 140 illustrated in FIG. 5A, i.e., the light guide plate 140 in which the incidence surface 144 is perpendicular to the exit surface 141, is curved in the above-described direction, a distance between the incidence surface 144 of the light guide plate 140 and the light emission surface 152 of the light source 151 increases and an amount of light leakage increases toward an upper side (in the z-axis direction).

However, as illustrated in FIGS. 7B and 7C, in cases where the light guide plate 140 illustrated in FIG. 5A is not curved and where the light guide plate 140 illustrated in FIG. 5B is curved in the above-described direction, an amount of light leakage is substantially similar to each other. That is, in the case where the light guide plate 140 illustrated in FIG. 6A, i.e., the light guide plate 140 in which the incidence surface 143 is inclined at a predetermined angle θ with respect to the exit surface 141, is curved in the above-described direction, a distance between the incidence surface 143 of the light guide plate 140 and the light emission surface 152 of the light source 151 may not become larger and may maintain at a substantially minimum and constant distance.

As described herein, in an exemplary embodiment of the display device, an amount of light leakage may be reduced and luminous efficiency may be improved, as the distance between the incidence surface 143 of the light guide plate 140 and the light emission surface 152 of the light source 151 may not become larger and may maintain a substantially minimum and constant distance.

As set forth hereinabove, in exemplary embodiments of a display device according to the invention, an amount of light leakage occurring at an edge of the display devices may be reduced, and thereby light incidence efficiency of a light guide plate may be increased and power consumption may be reduced.

While the invention has been illustrated and described with reference to the exemplary embodiments thereof, it will be apparent to those of ordinary skill in the art that various changes in form and detail may be made thereto without departing from the spirit and scope of the invention.

What is claimed is:

1. A display device comprising:
a display panel curved in a first direction;
a light source which emits a light; and
a light guide plate which guides the light from the light source toward the display panel,
wherein the light guide plate includes:
an exit surface curved in the first direction corresponding to a shape of the display panel; and
an incidence surface, which is defined by a side surface of the light guide plate in the first direction, wherein the light from the light source is incident onto the incidence surface, and
wherein the incidence surface is substantially parallel to a normal line at a central portion of the exit surface.

2. The display device of claim 1, wherein
the light source includes a light emission surface through which the light source emits the light, and
the light emission surface of the light source and the incidence surface of the light guide plate are substantially parallel to each other.

3. The display device of claim 1, further comprising:
a bottom chassis in which the light guide plate is accommodated, and the bottom chassis comprises:
a back surface portion curved in the first direction; and
a sidewall portion which is substantially parallel to the incidence surface of the light guide plate.

4. The display device of claim 3, further comprising:
a circuit board between the incidence surface of the light guide plate and the sidewall portion of the bottom chassis,
wherein the light source is disposed on the circuit board.

5. The display device of claim 4, further comprising:
an adhesive tape between the circuit board and the sidewall portion of the bottom chassis.

6. The display device of claim 3, further comprising:
a mold frame coupled to the bottom chassis,
wherein the mold frame fastens the light guide plate and supports the display panel.

7. The display device of claim 2, wherein the incidence surface of the light guide plate and the light emission surface of the light source are spaced apart from each other by a distance in a range from about 0.1 mm to about 0.5 mm.

8. The display device of claim 1, wherein
an angle between the incidence surface and the exit surface of the light guide plate is about (π/2-A/2R) radian,
wherein R denotes a radius of curvature of the light guide plate in the first direction, and A denotes a length of the light guide plate in the first direction.

9. The display device of claim 1, wherein a length of a side of the light guide plate in the first direction is greater than a length of a side of the light guide plate in a second direction which is perpendicular to the first direction.

10. The display device of claim 1, wherein the light source is disposed on opposite side surfaces of the light guide plate in the first direction.

11. The display device of claim 10, wherein
the light guide plate includes incidence surfaces, which are defined by the opposite side surfaces of the light guide plate in the first direction, respectively,
the light from the light source is incident onto the incidence surfaces, and
the incidence surfaces are substantially parallel to each other.

12. The display device of claim 1, wherein the display panel and the exit surface of the light guide plate are curved in a second direction which is perpendicular to the first direction.
